(19) United States
(12) Patent Application Publication
(10) Pub. No.: US 2022/0078378 A1
(43) Pub. Date: Mar. 10, 2022

(54) INFORMATION MANAGEMENT SYSTEM, AND IN-VEHICLE DEVICE AND IMAGE MANAGEMENT SERVER USED THEREIN

(71) Applicant: TOYOTA JIDOSHA KABUSHIKI KAISHA, Aichi-ken (JP)

(72) Inventors: Katsuhiko IWAZAKI, Aichi-ken (JP); Yu WATANABE, Aichi-ken (JP)

(21) Appl. No.: 17/469,802

(22) Filed: Sep. 8, 2021

(30) Foreign Application Priority Data
Sep. 9, 2020 (JP) 2020-151150

(51) Int. Cl. H04N 7/18; H04N 1/00; G06K 9/00

(52) U.S. Cl. CPC H04N 7/183; G06K 9/00791; H04N 1/00209; H04N 1/00244

(57) ABSTRACT

The in-vehicle device executes the vehicle side determination process for determining whether the selected image is a rare image using the selected image from photographed image stored in storage device and the detected vehicle state when photographing the selected image and transfers the vehicle state and the selected image when the selected image is determined to be a rare image by the execution of the vehicle side determination process to the portable device. The portable device transmits the selected image and the selected vehicle state to the image management server only when the transmission is permitted by the user. The image management server stores the selected image and the selected vehicle state transmitted from the portable terminal in the image storage device.

### CROSS-REFERENCE TO RELATED APPLICATIONS

The present disclosure claims priority to Japanese Patent Application No. 2020-151150 filed Sep. 9, 2020, which is incorporated herein by reference in its entirety including specification, drawings and claims.

### TECHNICAL FIELD

The present disclosure relates to an information management system, an in-vehicle device used therein and an image management server used therein.

### BACKGROUND

Conventionally, as a system of this type, there has been proposed a system including an edge device mounted on a vehicle together with a drive recorder, a drive recorder information server connected to a plurality of edge devices via a communication network, and an external server connected to the communication network (for example, see patent literature 1). In this system, the edge device extracts the feature information of the image taken by the drive recorder and detects whether or not a predetermined event such as a traffic accident has occurred based on the feature information. Then, when the edge device detects a predetermined event has occurred, the edge device transmits the characteristic information of the image when the predetermined event has been detected to the drive recorder information server together with the information of the position and time at which the image was photographed. The drive recorder information server generates accident summary information indicating a summary of a traffic accident that has occurred based on the information acquired from the edge device, and provides the accident summary information to the external server. The external server provides traffic accident information to a number of drivers utilizing the server.

### CITATION LIST

### Patent Literature

PTL 1: JP2019-197525

### SUMMARY

However, in the above-described system, feature information is extracted from an image photographed by the drive recorder, and when the feature information is extracted, the information of the image, the position, and the time is automatically transmitted to the drive recorder information server. Therefore, a large amount of images may be transmitted regardless of whether or not it is necessary. In this case, the amount of communication becomes excessive.

An information management system and an in-vehicle device and an image management server used therein according to the present disclosure have a main object of reducing a communication amount and a communication frequency of an image including a rare image between a user and the image management server.

The information management system of the present disclosure, the in-vehicle vehicle and the image management server used therein adopt the following means in order to achieve the above-mentioned main object.

An information management system of the present disclosure including: an-in vehicle device including, a camera mounted on a vehicle, a sensor configured to detect a vehicle state, a storage device configured to store an image photographed by the camera and the vehicle state detected by the sensor, along with the time photographed, as the photographed image and the detected vehicle state, a transfer device configured to transfer the captured image and the detected vehicle state, and a control device configured to control the camera and the transfer device; a portable device configured to acquire and transmit the photographed image and the detected vehicle state transferred from the transfer device; and an image management server configured to receive the photographed image and the detected vehicle state transmitted from the portable device, wherein the control device of the in-vehicle device, executes the vehicle side determination process for determining whether the selected image is a rare image using the selected image from photographed image stored in storage device and the detected vehicle state when photographing the selected image and transfer the vehicle state and the selected image when the selected image is determined to be a rare image by the execution of the vehicle side determination process to the portable device, wherein the portable device transmits the selected image and the selected vehicle state transferred from the in-vehicle device only when transmission is permitted by the user to the image management server, wherein the image management server includes an image storage device configured to store the selected image and the selected vehicle state received from the portable device.

In the information management system of the present disclosure, the in-vehicle device executes a vehicle side determination process for determining whether the selected image is a rare image by the vehicle side determination process using the detected vehicle state (selected vehicle state) when photographing the selected image and the selected image of the photographed image stored with the time taken by the camera and transfers the selected image and the selected vehicle-state to the portable device when the selected image is determined to be a rare image by execution of the vehicle side determination process. The portable device transmits the selected image and the selected vehicle state transferred from the in-vehicle device only when the transmission is permitted by the user to the image management server. The image management server stores the selected image and the selected vehicle state received from the portable device in the image storage device. Thus, in the information management system of the present disclosure, the selected image by the vehicle side determination process using the selected image by the in-vehicle device and the vehicle state (selected vehicle state) when the selected image is photographed is determined to be a rare image and the selected image and the selected vehicle state are transferred to the portable device. Then, the selected image and the selected vehicle state are transmitted from the portable device to the image management server only when the transmission is permitted by the user. For this reason, the communication amount and the communication frequency of the moving image including the rare image between the user and the image management server can be suppressed as compared with the case where the selected image that conforms to the predetermined condition is automatically transmitted to the image management server. The “image” includes a still image and a moving image, and the same applies to the following description.

The in-vehicle device of the present disclosure is an in-vehicle device constituting the information management system of the present disclosure described above. That is, the in-vehicle device used in information management system of the present disclosure, wherein the information management system including: the in-vehicle device including, a camera mounted on a vehicle, a sensor configured to detect a vehicle state, and a storage device configured to store a captured image taken by a camera and a vehicle state detected by the sensor with time as a captured image and the detected vehicle state, and a transfer device configured to transfer the captured image and the detected vehicle state, and a control device configured to control the camera and the transfer device; the portable device configured to acquire and transmit the photographed image and the detected vehicle state transferred from the transfer device; and an image management server configured to receive the photographed image and the detected vehicle state transmitted from the portable device, wherein the in-vehicle device of the control device, transfer the selected image among photographed image stored in storage device and the selected vehicle state, the vehicle state when photographing the selected image to the portable device, wherein the portable device transmit the selected image and the selected vehicle state transferred from the in-vehicle device to the image management server only when transmission is permitted by the user, wherein the image management server includes an image storage device for storing the selected image and the selected vehicle state received from the portable device, wherein the control device of thein-vehicle device, the selected image by using the selected image and the selected vehicle state executes a vehicle-side determination process for determining whether the selected image is a rare image, the selected image by execution of the vehicle-side determination process is determined to be a rare image and the selected vehicle state is to transfer to the portable device.

The in-vehicle device of the present disclosure is used in the information management system of the present disclosure. In the information management system comprising an in-vehicle device of the present disclosure, wherein the in-vehicle device executes the vehicle-side determination process for determining whether the selected image is a rare image using the selected image and the detected vehicle state when photographing the selected image in photographed image stored with time photographed by camera and transfers the vehicle state and the selected image when the selected image is determined to be a rare image by the execution of the vehicle-side determination process to the portable device. The portable device transmits the selected image and the selected vehicle state transferred from the in-vehicle device to the image management server only when transmission is permitted by the user. The image management server stores the selected image and the selected vehicle state received from the portable device in the image storage device. Thus, in the information management system comprising in-vehicle device of the present disclosure, the selected image by the vehicle-side determination process using the selected image by the in-vehicle device and the vehicle state (selected vehicle state) when the selected image is photographed is determined to be a rare image and the selected image and the selected vehicle state are transferred to the portable device. Then, the selected image and the selected vehicle state are transmitted from the portable device to the image management server only when the transmission is permitted by the user. For this reason, the communication volume and frequency of the moving image including the rare image between the user and the image management server can be reduced as compared with the case where the selected image automatically transmits the image that meets the predetermined conditions to the image management server.

The image management server of the present disclosure is an image management server constituting the information management system of the present disclosure described above. That is, in the image management server of the present disclosure, the image management server used in an information management system, wherein the information management system including: an-in vehicle device including, a camera mounted on a vehicle, a sensor configured to detect a vehicle state, a storage device configured to store an image photographed by the camera and the vehicle state detected by the sensor, along with the time photographed, as the photographed image and the detected vehicle state, a transfer device configured to transfer the captured image and the detected vehicle state, and a control device configured to control the camera and the transfer device; a portable device configured to acquire and transmit the photographed image and the detected vehicle state transferred from the transfer device; and the image management server configured to receive the photographed image and the detected vehicle state transmitted from the portable device, wherein the control device of the in-vehicle device executes the vehicle-side determination process for determining whether the selected image is a rare image using the selected image among photographed image stored in storage device and the detected vehicle state when photographing the selected image and transfers the vehicle state and the selected image when the selected image is determined to be a rare image by the execution of the vehicle-side determination process to the portable device, wherein the portable device transmits the selected image and the selected vehicle state transferred from the in-vehicle device only when transmission is permitted by the user to the image management server, wherein the image management server comprising an image storage device configured to store the selected image and the selected vehicle state received from the portable device, wherein the image management server configured to execute server side determination process for determining whether or not the selected image is a rare image using the selected image and the selected vehicle state received from the portable device, and stores the selected image determined to be a rare image in the image storage device by executing the server side determination process.

The image management server of the present disclosure is used in the information management system of the present disclosure. In the information management system comprising an image management server of the present disclosure, the in-vehicle device executes the vehicle side determination process for determining whether the selected image is a rare image by the vehicle side determination using the vehicle state (selected vehicle state) detected when photographing the selected image and the selected image among the photographed image stored with time taken by the camera, and transfer the selected image and the selected vehicle state that the selected image is determined to be rare images to the portable device by the execution of the vehicle side determination process. The portable device transmits the selected image and the selected vehicle state transferred from the in-vehicle device to the image management server only when the transmission is permitted by the user. The image management server stores the selected image and the selected vehicle state received from the portable device in the image storage device. Thus, in the information management system comprising the image management server of the present disclosure, the selected image by the vehicle-side determination process using the selected image by the in-vehicle device and the vehicle state (selected vehicle state) when the selected image is photographed is determined to be a rare image and the selected image and the selected vehicle state are transferred to the portable device. Then, the selected image and the selected vehicle state from the portable device are transmitted to the image management server only when the transmission is permitted by the user. For this reason, the communication volume and frequency of the moving image including the rare image between the user and the image management server can be reduced as compared with the case where the selected image automatically transmits the image that meets the predetermined conditions to the image management server. Further, since the image management server determines whether or not the selected image is a rare image for the selected image selected and permitted by the user and transmitted from the portable device, it is possible to impose a step sufficient for determining a rare image. As a result, it is possible to more appropriately determine and store the rare image.

### BRIEF DESCRIPTION OF DRAWINGS

FIG. 1 is a configuration diagram showing an outline of a configuration of an information management system 10 according to a first embodiment of the present disclosure;

FIG. 2 is a configuration diagram showing a schematic of a configuration of an in-vehicle device 20 provided with the information management system 10 of the first embodiment;

FIG. 3 is a flowchart showing an example of an image selection determination process performed by the electronic control unit 30 of the in-vehicle 20 when the user selects an image;

FIG. 4 is a flowchart showing an example of an image transmission process executed by the portable device 120;

FIG. 5 is a flowchart showing an example of an image storage process executed by the image management server 230 of the information management center 220;

FIG. 6 is a flowchart showing an example of an image storage process of a modification; and

FIG. 7 is a flowchart showing an example of an image selection determination process executed by the electronic control unit 30 of the in-vehicle 20 of the second embodiment.

### DETAILED DESCRIPTION OF EMBODIMENTS

The following describes some aspects of the present disclosure with reference to an embodiment.

### Example 1

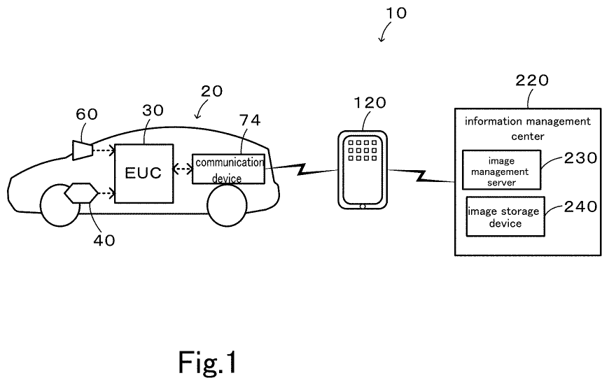

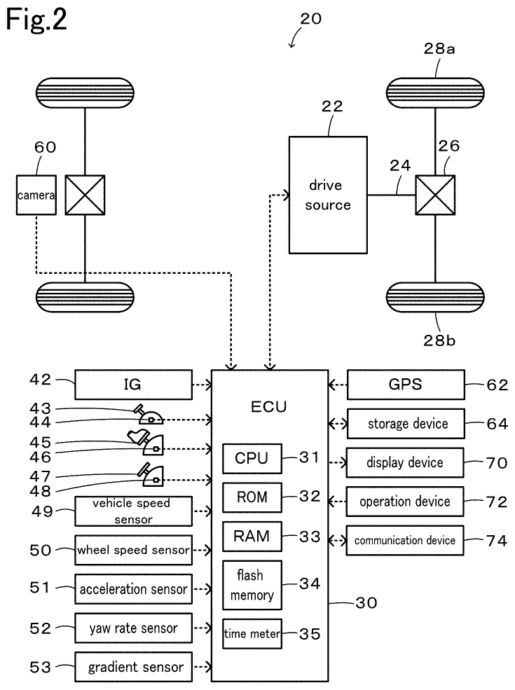

FIG. 1 is a configuration diagram showing an outline of a configuration of an information management system 10 as a first embodiment of the present disclosure, and FIG. 2 is a configuration diagram showing an outline of a configuration of an in-vehicle device 20 included in the information management system 10 of the first embodiment. As shown, the information management system 10 of the first embodiment includes an in-vehicle device 20 which is mounted, a portable device 120, and an image management center 220.

As shown in FIG. 2, the in-vehicle device 20 is mounted on a vehicle that travels by transmitting the driving force outputted from the drive source 22 to the driveshaft 24 to the drive wheels 28a and 28b via the differential gear 26. The drive source 22 may include an engine transmission system including an engine driven by using a hydrocarbon-based fuel such as gasoline or diesel oil and an automatic transmission, a hybrid system including an engine and a motor and a storage battery, an electric vehicle system including a motor and a storage battery, and a fuel cell system including a motor and a storage battery and a fuel cell.

The in-vehicle device 20 includes a camera 60, various sensors 40, a storage device 64, a display device 70, an operation device 72, a communication device 74, and an electronic control unit 30.

The camera 60 is disposed in front of the vehicle. A camera, for example, incorporated in the drive recorder storing vehicle speed, GPS (Global Positioning System) data, time, and photographed images may be used as the camera 60. The camera 60 may be disposed not only in front of the vehicle but also in the rear and lateral direction of the vehicle.

Various sensors 40 may include sensors detecting the status of a vehicle such as a vehicle speed sensor 49, a wheel speed sensor 50, an acceleration sensor 51, a yaw rate sensor 52, a gradient sensor 53, and a GPS (Global Positioning System) 62.

The storage device 64 is configured by, for example, a hard disk drive or an SSD (Solid State Drive. A storage device incorporated in a drive recorder or provided separately from a drive recorder may be used as the storage device 64.

Display device 70 is configured as, for example, a liquid crystal display. A display device incorporated in the drive recorder or provided separately from the drive recorder may be used as the display 70.

The operation device 72 includes switches used for displaying an image (including a moving image) stored in the storage device 64 on the display device 70 or editing an image (including a moving image) displayed on the display device 70. An operation device incorporated in a drive recorder or provided separately from a drive recorder may be used as the operation device 72.

The communication device 74 has a function of transferring an image (including a moving image) to the portable device 120 by wire or wireless (for example, a Bluetooth® function). A communication device incorporated in a drive recorder or provided separately from a drive recorder may be used as the communication device 74.

The electronic control unit 30 is a microcomputer configured around a CPU31. In addition to CPU31, the electronic control unit 30 includes a ROM32 for storing a program or the like, a RAM32 for temporarily storing data, a flash memory 34 for storing data or the like, a time meter 35 having a timer function or the like, an input/output port (not shown). The electronic control unit 30 may be incorporated into the drive recorder or provided separately from the drive recorder. Further, in the electronic control unit 30, the unit performing driving control of the vehicle and the unit editing, storing, and transferring the images photographed by the camera 60 may be separate.

The signals from the various sensors are input via the input port to the electronic control unit 30. The signals input to the electronic control unit 30 via the input port may include an ignition signal from the ignition switch 42, a shift position from the shift position sensor 44 for detecting the position of the shift lever 43, an accelerator opening degree from the accelerator pedal position sensor 46 for detecting the amount of depression of the accelerator pedal 45, and a brake position from the brake pedal position sensor 48 for detecting the amount of depression of the brake pedal 47. Further, the signals input to the electronic control unit 30 via the input port may include the vehicle speed from the vehicle speed sensor 49, the wheel speed from the wheel speed sensor 50, the acceleration from the acceleration sensor 51, the yaw rate from the yaw rate sensor 52, the road surface gradient from the gradient sensor 53, GPS data (position information) from GPS62, and the like. Furthermore, the operation signals of the switches of the operation device 72, various signals indicating the state of the drive source 22 from the drive source 22 can also be mentioned as the signals input to the electronic control unit 30 via the input port.

The electronic control unit 30 outputs various control signals via the output port. Examples of the control signal output from the electronic control unit 30 via the output port may include a control signal for storing an image (including a moving image) photographed by the camera 40 with the time taken in the storage device 64, a control signal for storing a signal indicating the state of the vehicle detected by various sensors together with the time in the storage device 64, a transfer control signal for outputting the image (including a moving image) to the communication device 74 when the image is transferred to the portable device 120, and the like.

The portable device 120 is configured as a smartphone having, for example, a function of a microcomputer and a telephone. The application software for acquiring an image transferred from the in-vehicle device 20 by wire or wireless and communicating with the information management center 220 via a communication network such as the Internet or a telephone line is installed win the portable device 120.

The information management center 220 includes an image management server 230, an image storage device 240, and a communication device 250. The image management server 230 is composed of a general-purpose microcomputer, and includes a program for communicating with the portable device 120 and a program for evaluating an image acquired by communicating with the portable device 120. The image storage device 240 is composed of, for example, a hard disk drive or an SSD (Solid State Drive).

In the vehicle device 20 in the information management system 10 of the embodiment, regardless of whether the ignition switch 42 is turned on or off, an image photographed by the camera 60 is always stored in the storage device 64 together with the time taken by camera. In the in-vehicle device 20, the vehicle state detected by the various sensors 40 is also stored in the storage device 64 together with the detection time regardless of whether the ignition switch 42 is turned on or off. The vehicle status includes at least a portion of, for example, a vehicle speed from the vehicle speed sensor 49, a wheel speed from the wheel speed sensor 50, an acceleration from the acceleration sensor 51, a yaw rate from the yaw rate sensor 52, a road surface gradient from the gradient sensor 53, GPS data (position information) from GPS62, and the like. The photographing by the camera 60 and the detection of the vehicle state by the various sensors 40 may be limited to when the ignition switch 42 is turned on.

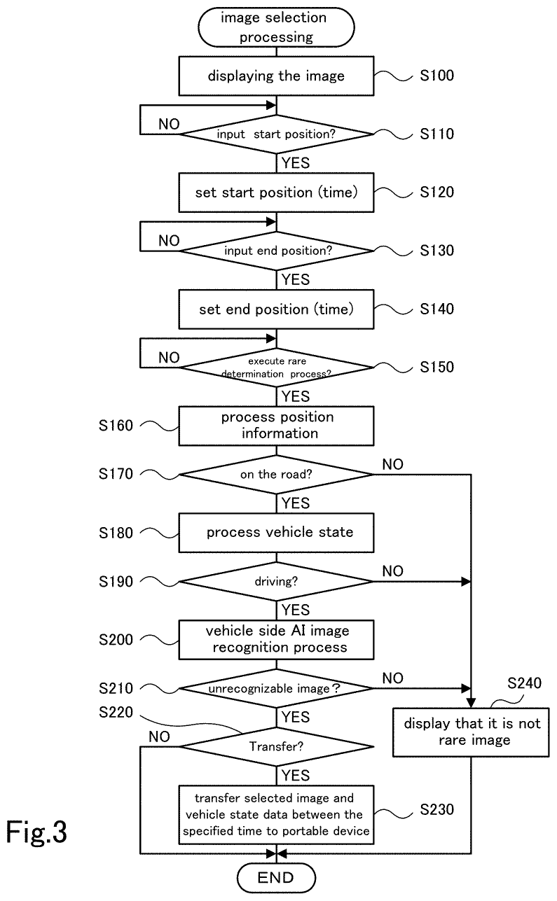

Next, the operation of the information management system 10 of the first embodiment configured as described above will be described. The user operates the switches of the operation device 74 of the in-vehicle device 20 to display an image (including a still image and a moving image; hereinafter, the same) stored in the storage device 64 on the display device 72, and selects a range of images to be transmitted to the information management center 220. FIG. 3 is a flowchart showing an example of an image selection determination process performed by the electronic control unit 30 of the in-vehicle device 20 when the user selects an image to be transmitted to the information management center 220.

When the image selection determination process is executed, the electronic control unit 30 starts the display of the image stored in the storage device 64 on the display device 72 (step S100). Next, the electronic control unit 30 waits for the start position (time) of the image to be transmitted to the information management center 220 to be input (step S110), and sets the input position (time) as the start position (time) (step S120). Specifically, when the user operates the fast-forward switch, or the return switch of the operation device 74 to input the start position of the image (moving image) to be transferred to the portable device 120, the position is set as the start position (start time). Next, the electronic control unit 30 waits for the end position (time) of the image to be input (step S130), the input position is set as the end position (time) (step S140). Similarly, when the user operates the fast forward switch, or the return switch of the operation device 74 to input the end position of the image to be transferred, the position is set as the end position. Hereinafter, an image from the start position (start time) to the end position (end time) will be referred to as a selected image.

Then, the electronic control unit 30 waits for the user to operate “execution” of the rare determination (step S150). When “execution” of the rare determination process is operated by the user, the electronic control unit 30 determines whether or not the shooting position of the selected image is on the road based on the GPS data (position information) included in the image data or the vehicle state data of the selected image (step S160, S170). For example, GPS data can be compared to a map to determine whether it is on a road. When it is determined that the photographing position of the selected image is not on the roads, it is determined that the selected image does not correspond to the rare image and is an unnecessary image, the image data of the selected image and the vehicle-state data are deleted (step S240), and the image selection determination process is terminated.

When it is determined in the step S170 that the shooting position of the selected image is on the road, it is determined whether or not the shooting of the selected image has been performed while the vehicle is running based on the vehicle status data (step S180, S190). For example, it is possible to determine whether or not the vehicle is driving based on whether or not the vehicle speed is equal to or higher than a threshold value, such as 3 km/h or 5 km/h. When it is determined that the photographing of the selected image is not performed while the vehicle is driving, it is determined that the selected image does not correspond to the rare image and is an unnecessary image, the image data of the selected image and the vehicle-state data are deleted (step S240), and the image selection determination process is terminated.

When it is determined that the shooting of the selected image is being performed in the step S180 during driving, the vehicle side AI image recognition process is performed on the selected image (step S200), and it is determined whether or not an object or an event in the selected image has been recognized (step S210). The vehicle side AI image recognition process is obtained by downloading the vehicle side AI image recognition process adjusted by using the server-side AI image recognition process updated by the image management server 230 at a predetermined timing in the first embodiment. As the server-side AI image recognition process, in the first embodiment, a solution is given to the objects and events in each image with respect to a large number of images determined to be rare images and stored in the image storage device 240, and the objects and events in each image are subjected to process learning, and the objects and events in the selected image are recognized using the learned model obtained by the machine learning. This machine learning is repeatedly performed at a timing at which a selected image as a rare image is stored in the image accumulating device 240, at a timing every predetermined period, or at a desired timing, and the server side AI image recognition process is updated. In the first embodiment, the vehicle side AI image recognition process is adjusted by using the server side AI image recognition process, which is downloaded and installed in the portable device 120. Therefore, in the process of the step S200, S2210, when it is determined that an object or an event of the selected image can be recognized by the portable side AI image recognizing process, it can be determined that the selected image is not a rare image. In this case, the selected image is judged as an unnecessary image, the image data of the selected image and the vehicle-state data are deleted (step S240), and the image selection judging process is terminated.

When it is determined in the step S200, S210 that an object or an event of the selected image cannot be recognized by the vehicle side AI image recognizing process, the selected image is determined to be a rare image. Then, it waits for the user to operate “transfer” of the selected image (step S220). When “transfer” is operated by the user, the image data of the selected image and the vehicle-state data are transferred to the portable device 120 (step S230), and the image selection determination process is terminated. The transfer from the in-vehicle device 20 to the portable device 120 is performed by the user when application software for connecting the portable device 120 and the in-vehicle device 20 by wired or wireless connection and acquiring an image transferred from the in-vehicle device 20 of the portable device 120 or communicating with the information management center 220 is activated.

The rare determination process of step S150, S210 of the image selection determination process of FIG. 3 is selective, and when the user does not operate “execute” in the rare determination process, the image selection determination process is terminated without performing the rare determination process or the transferring process of the step S220, S230. Further, the transfer process of the step S220, S230 is also selective, when the “transfer” is not operated by the user, the image selection determination process is terminated without transferring the selected image even if it is determined that it is a rare image by the rare determination process.

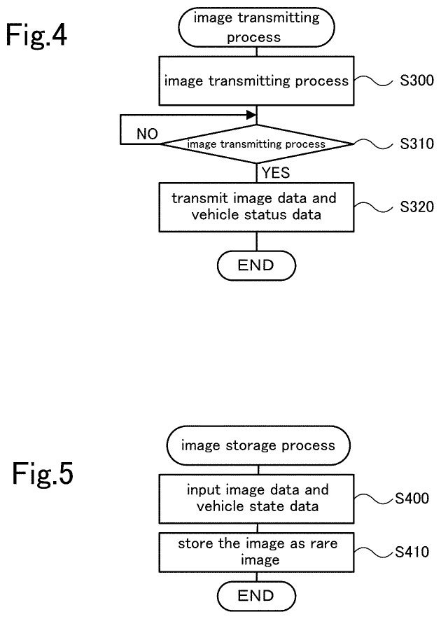

Next, an operation of the portable device 120 that has received the transfer of the selected image will be described. FIG. 4 is a flowchart showing an example of image transmission process executed by the portable device 120. This process is executed when the portable device 120 and the in-vehicle device 20 are connected by wire or wireless, and application software for acquiring an image transferred from the in-vehicle device 20 of the portable device 120 or communicating with the information management center 220 is activated.

When the image transmitting process is executed, the portable device 120 first acquires the image data of the selected image and the vehicle status data transferred from the in-vehicle device 20 (step 300). That is, when the step S300 is being executed, the step S220, S230 of the image selection determination process of FIG. 3 is executed, whereby the image data of the selected image and the vehicle status data are transferred from the in-vehicle device 20 and acquired by the portable device 120. In the subsequent process, whether or not the portable device 120 is connected to the in-vehicle device 20 by wired or wireless connection does not matter.

Next, it waits for the user to operate “transmission” for the acquired selected image (step S310). When “transmission” is operated by the user, the image data of the selected image and the vehicle-state data are transmitted to the information management center 20 (step S320), and the image transmission process is terminated. The transmission process of the selected image of the step S310, S320 is selective, and when the “transmission” is not operated by the user, the image transmission process is terminated without performing the transmission process.

Next, the operation of the image management server 230 of the information management center 220 will be described. FIG. 5 is a flowchart showing an example of image accumulation process executed by the image management server 230 of the information management center 220. When the image data of the selected image and the vehicle state data are transmitted from the portable device 120, the image management server 230 of the information management center 220 receives the image data of the selected image and the vehicle state data (step S400), stores the selected image as a rare image in the image storage device 240 (step S410), and ends the image storage process. Since the selected image is determined to be a rare image by the vehicle side AI image recognition process in the image selection determination process of the in-vehicle device 20, the image management server stores the selected image in the image storage device 240 as a rare image without performing the rare determination process on the selected image.

In the information management system 10 of the first embodiment described above, the in-vehicle device 20 determines whether or not the selected image is a rare image on the basis of the image data of the selected image selected by the user among the images photographed by the camera 60 and stored together with the time and the vehicle state data when the selected image is photographed. Then, the image data of the selected image determined that the selected image is a rare image and the vehicle state data are transferred to the portable device 120. The portable device 120 transmits the image data of the selected image and the vehicle state data to the image management server 230 only when the transmission is permitted by the user. Upon receiving the image data of the selected image and the vehicle state data, the image management server 230 stores the selected image in the image storage device 240 as a rare image. As described above, in the information management system 10 of the first embodiment, the in-vehicle device 20 determines whether or not the selected image is a rare image by the vehicle side AI image recognition process using the image data of the selected image and the vehicle state data, and transfers the image data of the selected image and the vehicle state data to the portable device 120 when the selected image is determined to be a rare image. Only when the transmission is permitted by the user, the image data of the selected image and the vehicle state data are transmitted to the image management server 230. For this reason, it enables to reduce the amount of communication and the frequency of communication of an image including a rare image between the user and the image management server 230, as compared with a case where a selected image that matches a predetermined condition is automatically transmitted to the image management server.

In the in-vehicle device 20 of the information management system 10 of the first embodiment, the selection image is judged whether or not the selection image is a rare image, waiting for the user to operate the “execution” of the rare determination process. However, when the selected image is set, it may be determined whether or not the selected image is a rare image without performing the user's operation.

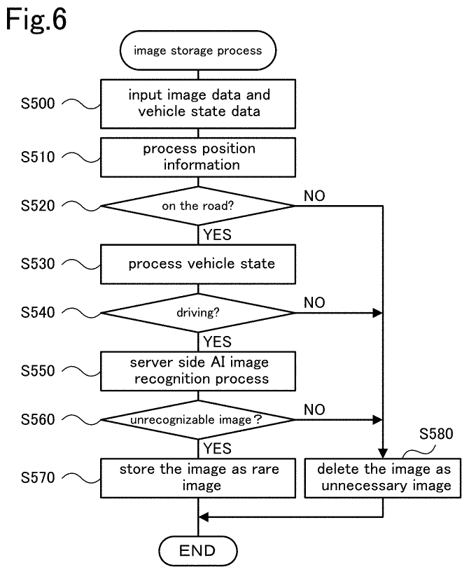

In the information management system 10 of the first embodiment, when the image data of the selected image and the vehicle state data transmitted from the portable terminal 120 are received, the image management server 230 stores the selected image in the image storage device 240 as a rare image. However, the rare determination may also be performed by the image management server 230. In this case, the image accumulation process of FIG. 6 may be performed instead of the image accumulation process of FIG. 5.

In the image accumulation process of FIG. 6, upon receiving the image data of the selected image and the vehicle state data (step S500), the image managing server 230 determines whether or not the selected image is photographed while driving on the roads based on the image data of the selected image or the vehicle state data (step S510˜S540) in the same manner as up to step S160˜S190 in the image selection determination process of FIG. 3 described above. When it is determined that the photographing position of the selected image is not on the roads, or when it is determined that the photographing of the selected image is not performed while the vehicle is driving, it is determined that the selected image does not correspond to the rare image and is an unnecessary image, the image data of the selected image and the vehicle-state data are deleted (step S580), and the image accumulation process is terminated. When it is determined in step S510˜S540 that the selected image is taken while driving on the roads, the server-side AI image recognizing process is performed on the selected image (step S550), and it is determined whether or not an object or an event in the selected image has been recognized (step S560). Server-side AI image recognition process is described above. When it is determined that the matter or event of the selected image cannot be recognized by the server-side AI image recognizing process, the selected image is determined to be a rare image, the selected image is stored in the image accumulating device 240 (step S570), and the image accumulating process is terminated. On the other hand, when it is determined that the matter or event of the selected image can be recognized by the server-side AI image recognizing process, it is determined that the selected image is not a rare image but an unnecessary image, the image data of the selected image and the vehicle-state data are deleted (step S580), and the image accumulating process is terminated.

By such image accumulation process, only an image photographed while driving on the road among the selected images transmitted from the portable terminal 120, in which an event or an event of the image cannot be recognized by the server-side AI image recognition process, can be stored in the image accumulation device 240 as a rare image. The rare image stored in the image storage device 240 is not only used in the above-described server-side AI image recognition process and the portable side AI image recognition process, but also used for image recognition process in automatic operation, analysis of an accident, and accident information when the rare image is an accident image. If the image storage process of FIG. 6 is performed by the image management server 230 in this manner, it is possible to more appropriately determine and store the rare image.

In the image accumulation process of FIG. 6, when the selected image is not photographed while driving on the road, the determination of the rare image by the server side AI image recognition process is not performed. However, it may be assumed that the determination of the rare image by the server-side AI image recognition process if the selected image is taken on the road even if it is not running, or that the determination of the rare image by the server side AI image recognition process if the selected image is taken on the road even if it is not on the road, or that the determination of the rare image by the server-side AI image recognition process with respect to the selected image taken regardless of whether or not it is on the road and it is running.

In the image accumulation process of FIG. 6, when the selected image is not photographed while driving on the road, the determination of the rare image by the server side AI image recognition process is not performed. However, the rare image may be determined by the server side AI image recognition process when the selected image is photographed on the road, while driving, and under the predetermined condition below. For example, the predetermined condition is: a state in which the acceleration is equal to or greater than the first reference value or less than the second threshold value; a state in which the yaw rate is equal to or greater than the third threshold value or less than the fourth threshold value; or a state in which the road surface gradient is equal to or greater than the fifth threshold value or less than the sixth threshold value.

### Example 2

Next, the information management system 510 according to the second embodiment of the present disclosure will be described. The information management system. 510 of the second embodiment has the same hardware configuration as that of the information management system 10 of the first embodiment illustrated in FIGS. 1 and 2. Accordingly, a description of the hardware configuration of the information management system 510 according to the second embodiment will be omitted.

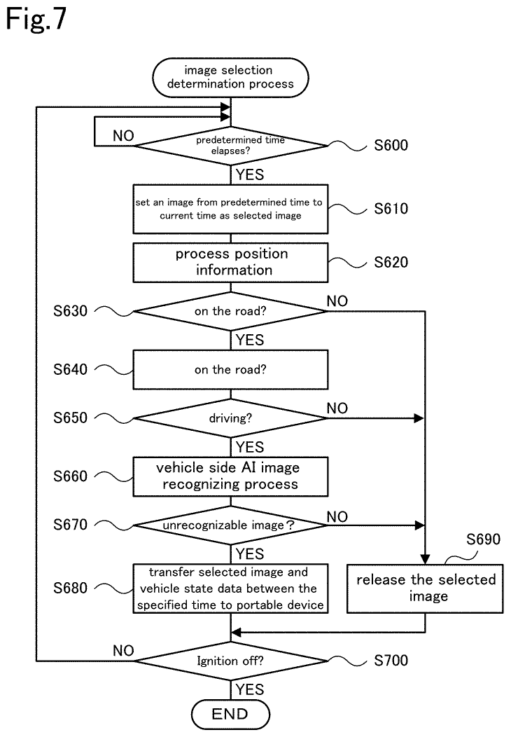

In the in-vehicle device 20 of the information management system 510 of the second embodiment, the image selection determination process shown in FIG. 7 is executed. This process is executed when the ignition switch 42 is turned on.

When the image selection determination process is executed, the electronic control unit 30 waits for a predetermined period of time to elapse in step S600. The predetermined time may be, for example, 5 seconds or 10 seconds. When a predetermined time has elapsed, an image photographed by the camera 60 from a predetermined time prior to the current time is set as a selected image (step S610).

Next, a rare determination process (step S620˜S670) is performed to determine whether or not the selected image is a rare image using the set image data of the selected image and the vehicle-state data. This rare determination process is the same as the process of step S180˜S210 in the image-selection determination process of FIG. 3, which is executed by the in-vehicle device 20 of the information-management system 10 of the first embodiment.

When it is determined in step S620˜S670 that the photographing of the selected image is being performed while driving on the roads and that the matter or event of the selected image cannot be recognized by the vehicle side AI image recognizing process, it is determined that the selected image is a rare image, and the image data of the selected image and the vehicle status data are transferred to the portable device 120 (step S680). Then, it is determined whether or not the ignition switch 42 is turned off (step S700), and when it is determined that the ignition switch 42 is not turned off, the process returns to the process of waiting for the elapse of a predetermined period of time in step S600. On the other hand, when it is determined that the ignition switch 42 is turned off, the image selection determination process is terminated.

When it is determined in step S630 that the photographing of the selected image is not performed on the roads, when it is determined in step S650 that the photographing of the selected image is not performed while the vehicle is driving, or when it is determined in step S670 that the object or event of the selected image is recognized by the vehicle side AI image recognizing process, it is determined that the selected image is not a rare image, and the setting of the selected image is released (step S690). Then, it is determined whether or not the ignition switch 42 is turned off (step S700), and when it is determined that the ignition switch 42 is not turned off, the process returns to the process of waiting for the elapse of a predetermined period of time in step S600. On the other hand, when it is determined that the ignition switch 42 is turned off, the image selection determination process is terminated.

In the information management system 510 of the second embodiment, similarly to the information management system 10 of the first embodiment, the image transmission process of FIG. 4 is executed in the portable terminal 120, and the image accumulation process of FIG. 5 is executed in the image management server 230 of the information management center 220. Description of these processes is omitted.

In the information management system 510 of the second embodiment described above, the in-vehicle device 20 sets an image photographed by the camera 60 from a predetermined time before to a current time as a selected image every time a predetermined time elapses, and determines whether or not the selected image is a rare image based on image data of the selected image and vehicle state data when the selected image is photographed. When it is determined that the selected image is a rare image, the image data of the selected image and the vehicle state data are transferred to the portable device 120. The portable device 120 transmits the image data of the selected image and the vehicle state data to the image management server 230 only when the transmission is permitted by the user. Upon receiving the image data of the selected image and the vehicle state data, the image management server 230 stores the selected image in the image storage device 240 as a rare image. As described above, in the information management system 10 of the second embodiment, the in-vehicle device 20 sets the selected image every predetermined time, determines whether the selected image is a rare image, and transfers the image data of the selected image determined to be a rare image and the vehicle state data to the portable device 120. Only when the transmission is permitted by the user, the image data of the selected image and the vehicle state data are transmitted to the image management server 230. For this reason, the communication volume and frequency of the moving image including the rare image between the user and the image management server 230 can be suppressed as compared with the case where the selected image automatically is transmitted from the selected images that meets the predetermined conditions to the image management server.

In the in-vehicle device 20 of the information management system 510 of the second embodiment, the selected image is set every time a predetermined time elapses, and it is determined whether or not the selected image is a rare image. However, an image taken at the same time as the photographing of the camera 60 is set as a selected image may be used to determine whether or not the selected image is a rare image. In this case, when it is determined that the selected image is a rare image, an image which is a predetermined time (for example, 5 seconds) before the image determined as the rare image is set as the start position (start time), and an image which is a predetermined time (for example, 5 seconds) after the image which is no longer determined as the rare image is set as the end position (end time), and an image from the start position (start time) to the end position (end time) may be set as the selected image and transferred to the portable device 120.

In the in-vehicle device 20 of the information management system 510 of the second embodiment, when the ignition switch 42 is turned on, the selected image is set every time a predetermined time elapses, and it is determined whether or not the selected image is a rare image. However, after the ignition switch 40 is turned off, an image taken by the camera 60 may be set as a selected image from the time the ignition switch 42 is turned on until it is turned off, and it may be determined whether the selected image is a rare image or not. In this case, the image taken by the camera 60 from the time when the ignition switch 42 is turned on to the time when it is turned off may be divided at predetermined time intervals and sequentially set to the selected image to determine whether the selected image is a rare image or not.

In the information management system 510 of the second embodiment, the image management server 230, upon receiving the image data of the selected image and the vehicle state data transmitted from the portable terminal 120, stores the selected image in the image storage device 240 as a rare image. However, the rare determination may also be performed by the image management server 230 by performing the image accumulation process of FIG. 6 or the process of the modification thereof.

In the in-vehicle device 20 of the information management system 10 of the first embodiment and the information management system 510 of the second embodiment, when the selected image is not taken while driving on the road, the determination of the rare image by the vehicle side AI image recognition process may not be performed. However, it is assumed that the determination of the rare image by the vehicle side AI image recognition process if the selected image is taken on the road even if it is not running, or if the selected image is taken on the road while driving on the road it is intended to determine the rare image by the vehicle side AI image recognition process, or it may be intended to determine the rare image by the vehicle side AI image recognition process with respect to the selected image taken regardless of whether or not it is on the road.

In the in-vehicle device 20 of the information management system 10 of the first embodiment and the information management system 510 of the second embodiment, when the selected image is not taken while driving on the road, the determination of the rare image by the vehicle side AI image recognition process may not be performed. However, the rare image may be determined by the vehicle side AI image recognition process when the selected image is photographed on the road, while driving, and under the predetermined condition below. For example, the predetermined condition is: a state in which the acceleration is equal to or greater than the first reference value or less than the second threshold value; a state in which the yaw rate is equal to or greater than the third threshold value or less than the fourth threshold value; or a state in which the road surface gradient is equal to or greater than the fifth threshold value or less than the sixth threshold value.

In the in-vehicle device 20 of the information management system 510 of the second embodiment and the information management system 10 of the first embodiment, as the vehicle side AI image recognition process, the vehicle side AI image recognition process adjusted using the server side AI image recognition process updated at a predetermined timing by the image management server 230 is downloaded and installed. However, the server side AI image recognition process may not be used as long as it is adjusted by using the result of machine learning (learned model) at a predetermined timing based on the rare image stored in the image recognition device 240.

In the embodiment, the present disclosure has been described as a form of the information management system 10 or the information management system 510, but the present disclosure may be a form of the in-vehicle device 20 provided in the information management system 10 or the information management system 510, a form of the mobile device 120 provided in the information management system 10 or the information management system 510, or a form of the image management server 230 provided in the information management system 10 or the information management system 510.

In the information management system of the present disclosure, the control device of the in-vehicle device may select an image in a specified range as the selected image when a start position and an end position are specified by a user with respect to the photographed image. That is, the selected image is selected by the user's operation. In this way, the user can select an image that he or she feels is a rare image as a selected image.

In the information management system of the present disclosure, the control device of the in-vehicle device may select an image of a predetermined range of the photographed image at a predetermined timing as the selected image. That is, the selected image is automatically selected at every predetermined timing. For example, the selected image may be selected every predetermined time, or the selected image may be selected every time the vehicle is ignited off (shutdown). alternatively, the photographed image may be selected following way. First, the photographed image may be selected immediately after photographing as the selected image, and the vehicle side determination process may be performed on the selected image. Second, when the selected image is determined to be the rare image, it may reselect the image photographed a few seconds or minutes before and after the rare image is photographed as the selected image. In this way, it is not necessary to select the selected image by the user.

In the information management system of the present disclosure, the vehicle side determination process may be a process of determining whether or not the selected image is a rare image by evaluating the selected image based on a past image stored in the image storage device. Past images stored in the image storage device can be used. In this case, the vehicle side determination process may be a process of determining that the selected image is a rare image when the object or event in the selected image cannot be recognized based on a result of learning about the object or event in the past image stored in the image storage device. That is, whether the selected image is a rare image may be determined on the basis of whether the object or event in the selected image can be recognized by the artificial intelligence image recognition process constructed by image recognition of the object or event in the past image stored in the image accumulation device. In these cases, the vehicle side determination process may be a process of determining whether or not the selected image is a rare image when the selected image is an image photographed while driving on a road based on the selected vehicle state. In this way, it can be limited to images photographed when the vehicle is driving on the road.

In the information management system of the present disclosure, the image management server may execute server side determination process for determining whether or not the selected image is a rare image using the selected image and the selected vehicle state received from the portable device, and may store the selected image determined to be a rare image in the image storage device by executing the server side determination process. In this way, the image management server determines whether or not the selected image is a rare image for the selected image selected and permitted by the user and transmitted from the portable device, so that a step sufficient for determining a rare image can be imposed. As a result, it is possible to more appropriately determine and store the rare image. In this case, the server side determination process may be a process of determining that the selected image is a rare image when the object or event cannot be recognized based on the result of learning on the object or event in the past image stored in the image storage device, and may be a process of performing the learning at a predetermined timing, and the terminal side determination process may be a process of using the result of performing the learning at a specific past timing. In this case, the terminal side determination process can be performed using the server side determination process, and a more appropriately selected image and the selected vehicle state can be transmitted from the portable device to the image management server. Further, in this case, the server side determination process may be a process of determining whether or not the selected image is a rare image when the selected image is an image photographed while driving on a road based on the selected vehicle state. In this way, it enables to limit to images photographed when the vehicle is driving on the road.

In the in-vehicle device of the present disclosure, the control device may select an image in a specified range as the selected image when a start position and an end position are specified by a user with respect to the photographed image. That is, the selected image is selected by the user's operation. In this way, the user can select an image that he or she feels is a rare image as the selected image.

In the in-vehicle device of the present disclosure, the control device may select an image of a predetermined range of the photographed image at a predetermined timing as the selected image. That is, the selected image is automatically selected at every predetermined timing. For example, the selected image may be selected every predetermined time, or the selected image may be selected every time the vehicle is ignited off (shutdown). Alternatively, the photographed image may be selected following way. First, the photographed image may be selected immediately after photographing as the selected image, and the vehicle side determination process may be performed on the selected image. Second, when the selected image is determined to be the rare image, it may reselect the image photographed a few seconds or minutes before and after the rare image is photographed as the selected image. In this way, it is not necessary to select the selected image by the user.

In the in-vehicle device of the present disclosure, the vehicle side determination process may be a process of determining whether or not the selected image is a rare image by evaluating the selected image based on a past image stored in the image storage device. Past images stored in the image storage device can be used. In this case, the vehicle side determination process may be a process of determining that the selected image is a rare image when the object or event in the selected image cannot be recognized based on a result of learning about the object or event in the past image stored in the image storage device. That is, whether the selected image is a rare image or not may be determined on the basis of whether the object or event in the selected image can be recognized by the artificial intelligence image recognition process constructed by image recognition of the object or event in the past image stored in the image storage device. In these cases, the vehicle side determination process may be a process of determining whether or not the selected image is a rare image when the selected image is an image photographed while driving on a road based on the selected vehicle state. In this way, it enables to limit to images photographed when the vehicle is driving on the road.

In the image management server of the present disclosure, the server side determination process may be a process, in which a predetermined determination process for determining whether or not the selected image is a rare moving image by evaluating the selected image based on a past moving image stored in the image storage device, updated at a predetermined timing, and the portable side determination process may be a process in which the determination accuracy of at least a part of the server side determination process or the server side determination process updated at a specific past timing is lowered. In this way, the image management server determines whether or not the selected image is a rare image for the selected image selected and permitted by the user and transmitted from the portable device, so that a step sufficient for determining a rare image can be imposed. As a result, it is possible to more appropriately determine and store the rare image.

In the image management server of the present disclosure, the server side determination process may be a process for determining that an object or an event in the selected image is a rare image when it cannot be recognized based on a result of learning on an object or an event in a past image stored in the image storage device, and the learning is performed at a predetermined timing, and the portable side determination process may be a process using a result of performing the learning at a specific timing in the past. In this case, the portable side determination process can be performed using the server side determination process, and a more appropriately selected image and the selected vehicle state can be transmitted from the portable device to the image management server. Further, in this case, the server side determination process may be a process of determining whether or not the selected image is a rare image when the selected image is an image photographed while driving on a road based on the selected vehicle state. In this way, it can be limited to images photographed when the vehicle is driving on the road.

The following describes the correspondence relationship between the primary components of the embodiment and the primary components of the disclosure described in Summary. In the embodiment, the camera 60 corresponds to a camera, various sensors 40 corresponds to sensors, the storage device 64 corresponds to a storage device, the communication device 74 corresponds to a transfer device, the electronic control unit 30 corresponds to a control device, the in-vehicle device 20 corresponds to an in-vehicle device. The portable device 120 corresponds to a “portable device”, the image management server 230 corresponds to an “image management server”, and the image storage device 240 corresponds to an “image storage device”.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The present invention can be applied to the manufacturing industry of an information management system and a portable device and an image management server used for the information management system.

1. An information management system comprising:
an-in vehicle device including, a camera mounted on a vehicle, a sensor configured to detect a vehicle state, a storage device configured to store an image photographed by the camera and the vehicle state detected by the sensor, along with the time photographed, as the photographed image and the detected vehicle state, a transfer device configured to transfer the captured image and the detected vehicle state, and a control device configured to control the camera and the transfer device;
a portable device configured to acquire and transmit the photographed image and the detected vehicle state transferred from the transfer device; and
an image management server configured to receive the photographed image and the detected vehicle state transmitted from the portable device,
wherein the control device of the in-vehicle device executes the vehicle side determination process for whether the selected image is a rare image using the selected image among photographed image stored in storage device and the detected vehicle state when photographing the selected image and transfer the vehicle state and the selected image when the selected image is determined to be a rare image by the execution of the vehicle side determination process to the portable device,
wherein the portable device transmits the selected image and the selected vehicle state transferred from the in-vehicle device only when transmission is permitted by the user to the image management server,
wherein the image management server comprising an image storage device configured to store the selected image and the selected vehicle state received from the portable device.

2. The information management system according to claim 1, wherein the control device of the in-vehicle device selects an image in a specified range as the selected image when a start position and an end position are specified by a user with respect to the photographed image.

3. The information management system according to claim 1, wherein the control device of the in-vehicle device selects an image of a predetermined range of the photographed image at a predetermined timing as the selected image.

4. The information management system according to claim 1, wherein the vehicle side determination process determines whether or not the selected image is a rare image by evaluating the selected image based on a past image stored in the image storage device.

5. The information management system according to claim 4, wherein the vehicle side determination process determines that the selected image is a rare image when the object or event in the selected image cannot be recognized based on a result of learning about the object or event in the past image stored in the image storage device.

6. The information management system according to claim 4, wherein the vehicle side determination process determines whether or not the selected image is a rare image when the selected image is an image photographed while driving on a road based on the selected vehicle state.

7. The information management system according to claim 1, wherein the image management server executes server side determination process for determining whether or not the selected image is a rare image using the selected image and the selected vehicle state received from the portable device, and stores the selected image determined to be a rare image in the image storage device by executing the server side determination process.

8. The information management system according to claim 7, wherein the server side determination process determines that the selected image is a rare image when the object or event cannot be recognized based on the result of learning on the object or event in the past image stored in the image storage device, and performs the learning at a predetermined timing, and the terminal side determination process uses the result of performing the learning at a specific past timing.

9. The information management system according to claim 7, wherein the server side determination process determines whether or not the selected image is a rare image when the selected image is an image photographed while driving on a road based on the selected vehicle state.

10. An in-vehicle device used in an information management system, wherein the information management system comprising:
the in vehicle device, a camera mounted on a vehicle, a sensor configured to detect a vehicle state, a storage device configured to store an image photographed by the camera and the vehicle state detected by the sensor, along with the time photographed, as the photographed image and the detected vehicle state, a transfer device configured to transfer the captured image and the detected vehicle state, and a control device configured to control the camera and the transfer device;
a portable device configured to acquire and transmit the photographed image and the detected vehicle state transferred from the transfer device; and an image management server configured to receive the photographed image and the detected vehicle state transmitted from the portable device,
wherein the control device of the in-vehicle device transfers the selected image selected from photographed images stored in the image storage device and the detected vehicle state when photographing the selected image to the portable device,
wherein the portable device transmits the selected image and the selected vehicle state transferred from the in-vehicle device only when transmission is permitted by the user to the image management server,
wherein the image management server comprising an image storage device configured to store the selected image and the selected vehicle state received from the portable device,
wherein the control device of the in-vehicle device configured to execute the vehicle side determination process for determining whether the selected image is a rare image using the selected image among photographed image stored in storage device and the detected vehicle state when photographing the selected image and transfer the vehicle state and the selected image when the selected image is determined to be a rare image by the execution of the vehicle side determination process to the portable device.

11. The in-vehicle device according to claim 10, the control device of the in-vehicle device selects an image in a specified range as the selected image when a start position and an end position are specified by a user with respect to the photographed image.

12. The in-vehicle device according to claim 10, wherein the control device of the in-vehicle device selects an image of a predetermined range of the photographed image at a predetermined timing as the selected image.

13. The in-vehicle device according to claim 10, wherein the in-vehicle side determination process determines whether or not the selected image is a rare image by evaluating the selected image based on a past image stored in the image storage device.

14. The in-vehicle device according to claim 13, wherein the in-vehicle side determination process determines that the selected image is a rare image when the object or event in the selected image cannot be recognized based on a result of learning about the object or event in the past image stored in the image storage device.

15. The in-vehicle device of according to claim 13, wherein the vehicle side determination process determines whether or not the selected image is a rare image when the selected image is an image photographed while driving on a road based on the selected vehicle state.

16. An image management server used in an information management system, wherein the information management system comprising:
an-in vehicle device including, a camera mounted on a vehicle, a sensor configured to detect a vehicle state, a storage device configured to store an image photographed by the camera and the vehicle state detected by the sensor, along with the time photographed, as the photographed image and the detected vehicle state, a transfer device configured to transfer the captured image and the detected vehicle state, and a control device configured to control the camera and the transfer device;
a portable device configured to acquire and transmit the photographed image and the detected vehicle state transferred from the transfer device; and
the image management server configured to receive the photographed image and the detected vehicle state transmitted from the portable device,
wherein the control device of the in-vehicle device executes the vehicle side determination process for determining whether the selected image is a rare image using the selected image among photographed image stored in storage device and the detected vehicle state when photographing the selected image and transfer the vehicle state and the selected image when the selected image is determined to be a rare image by the execution of the vehicle side determination process to the portable device,
wherein the portable device transmits the selected image and the selected vehicle state transferred from the in-vehicle device only when transmission is permitted by the user to the image management server,
wherein the image management server comprising an image storage device configured to store the selected image and the selected vehicle state received from the portable device,
wherein the image management server configured to execute server side determination process for determining whether or not the selected image is a rare image using the selected image and the selected vehicle state received from the portable device, and stores the selected image determined to be a rare image in the image storage device by executing the server side determination process.

17. The image management server according to claim 16, wherein the server side determination process determines that the selected image is a rare image when the object or event cannot be recognized based on the result of learning on the object or event in the past image stored in the image storage device, and performs the learning at a predetermined timing, and the terminal side determination process uses the result of performing the learning at a specific past timing.

18. The information management system according to claim 17, wherein the server side determination process determines whether or not the selected image is a rare image when the selected image is an image photographed while driving on a road based on the selected vehicle state.
